(19) United States
(12) Patent Application Publication
(10) Pub. No.: US 2023/0038099 A1
(43) Pub. Date: Feb. 9, 2023

(54) HEAT DISSIPATION CAP FOR STATOR, AND STATOR ASSEMBLY AND MOTOR COMPRISING SAME

(71) Applicant: AMOGREENTECH CO., LTD., Gimpo-si (KR)

(72) Inventor: Min Ho WON, Gimpo-si (KR)

(21) Appl. No.: 17/757,704

(22) PCT Filed: Dec. 21, 2020
(86) PCT No.: PCT/KR2020/018743

§ 371 Date: Jun. 17, 2022

(30) Foreign Application Priority Data
Dec. 19, 2019 (KR) 10-2019-0170786

(51) Int. Cl. H02K 9/22; H02K 3/24; H02K 3/48

(52) U.S. Cl. CPC H02K 9/227; H02K 3/24; H02K 3/48

(57) ABSTRACT

Provided is a stator assembly comprising a stator including a stator core having a cylindrical shape and a through hole through which two ends communicate with an outside and a wound coil having parts protruding to the outside further than the two ends of the stator core in an axial direction of the stator core and the remaining part positioned in the stator core and heat dissipation caps which are provided on two end portions of the stator core such that the protruding parts of the wound coil are accommodated in contact with an outer surface of the stator core. Therefore, a heat radiation path capable of transferring heat generated by or transferred to a stator coil to the outside increases, heat dissipation efficiency is improved, heat dissipation properties are superior, and thus a decrease in operational efficiency of a motor due to heat generation may be minimized or prevented.

### TECHNICAL FIELD

The present invention relates to a heat dissipation cap, and specifically, to a heat dissipation cap coupled to a motor stator.

### BACKGROUND ART

Motors are apparatuses which convert electrical energy to mechanical energy. Generally, a motor has a structure in which a stator and a rotor are included in a housing, the stator is coupled to an inner side of the housing, and the stator is formed by winding a coil around a cylindrical stator core in which a plurality of cores are stacked. In addition, the rotor is disposed inside the stator to be spaced a predetermined distance from an inner surface of the stator, and permanent magnets are disposed on an outer surface of a rotor core in a circumferential direction to react to an electromagnetic force generated by a stator coil when a current is applied. In addition, a rotary shaft for transmitting a rotational force of the rotor to the outside is installed in a central portion of the rotor, and in general, two end portions of the rotary shaft are fixedly supported by two side portions of the housing.

Generally, dissipation of heat generated according to driving of a motor is performed by a cooling unit provided in a housing, a cooling unit provided between the housing and an outer surface of a stator, and the like. However, since two ends of a wound coil coupled to a stator core are positioned to protrude toward the outside further than the stator core and exposed to air, it is difficult for a heat structure using the cooling units to quickly transfer all heat generated by or transferred to the wound coil coupled to the stator core toward the cooling units, and thus, there are problems that a loss of an electromagnetic force occurs when the motor is driven, and driving efficiency of the motor is lowered.

### DISCLOSURE

### Technical Problem

The present invention is directed to providing a heat dissipation cap for a stator assembly in which a heat radiation path capable of transferring heat generated by or transferred to a stator coil in a motor is increased and which improves heat dissipation efficiency, and a stator assembly and a motor which include the same.

In addition, the present invention is also directed to providing a heat dissipation cap for a stator assembly which is very easily coupled to a formed stator core to improve heat dissipation and minimize an increase in manufacturing time or cost added according to forming of the heat dissipation cap for a stator assembly.

In addition, the present invention is also directed to providing a heat dissipation cap for a stator assembly which has a superior mechanical strength, a bonding strength, and a heat resistance property after coupled to a stator core, has superior durability against vibrations and high temperatures generated when a motor is driven, and has a desired effect for a long time.

In addition, the present invention is also directed to providing a heat dissipation cap for a stator assembly having insulation properties through the heat dissipation cap even when additional insulation coating that is performed on an end of a wound coil is omitted because of superior insulation properties.

### Technical Solution

One aspect of the present invention provides a stator assembly including a stator including a stator core having a cylindrical shape and a through hole through which two ends communicate with an outside and a wound coil having parts protruding to the outside further than the two ends of the stator core in an axial direction of the stator core and the remaining part positioned in the stator core and heat dissipation caps which are provided on two end portions of the stator core such that the protruding parts of the wound coil are accommodated in contact with an outer surface of the stator core.

The wound coil may be formed by winding a conductive wire member or coupling and connecting a plurality of hairpins to a plurality of slots provided in a circumferential direction of the stator core to pass through the two ends of the stator core.

Each of the heat dissipation caps may include a heat radiation exterior member molded to have an accommodation portion which accommodates one protruding end portion of the wound coil and a heat transfer filling material which fills a space between the heat radiation exterior member and the accommodated wound coil.

A through hole corresponding to the through hole of the stator core may be formed in a central portion of the heat radiation exterior member, and the heat radiation exterior member may include the accommodation portion having an open front end to correspond to the one protruding end portion of the wound coil in a circumferential direction.

The heat radiation exterior member may be formed by curing an exterior material resin composition including a first curable base resin and a first heat dissipation filler.

The heat transfer filling material may be formed by curing a heat dissipation filling composition including a second curable base resin and a second heat dissipation filler after the wound coil is accommodated in the heat radiation exterior member.

The heat radiation exterior member may have a tensile strength of 2.5 kgf/mm² or more and a flexural strength of 7.0 kgf/mm² or more based on KS M 3015, and have an IZOD impact strength may be 11 kJ/m² or more.

The heat radiation exterior member may have an insulation resistance of 1.0×10¹³Ω or more, an arc-resistance of 180 seconds or more, and a thermal deformation temperature of 190° C. or more.

The heat transfer filling material may have a volume resistance of 2×10¹¹ Ω·cm or more based on ASTM D 257, a dielectric breakdown strength of 9 kV/mm or more based on ASTM 149, and a thermal conductivity of 0.5 W/mk or more based on ASTM E 1530.

The heat dissipation cap may be fixed to the stator core using a coupling member.

Another aspect of the present invention provides a heat dissipation cap for a stator, which is coupled to one end portion of a stator core to radiate heat of a wound coil wound around the stator core of a motor, the heat dissipation cap including a heat radiation exterior member molded to form an accommodation portion which accommodates one end portion of the wound coil and a heat dissipation filling composition provided in the accommodation portion to fill a space between the heat radiation exterior member and the wound coil after the one end portion of the wound coil is accommodated in the accommodation portion.

The heat dissipation filling composition may include a second curable base resin, and the second curable base resin may be in an uncured or partially cured state.

Still another aspect of the present invention provides a motor including the stator assembly according to the present invention, a rotor accommodated in a through hole inside a stator core of the stator assembly, and a housing which accommodates a stator assembly to be in contact with an outer surface of the stator core of the stator assembly and includes a cooling channel in a region corresponding to the outer surface of the stator core.

At least a part of an outer surface of the heat dissipation cap in the stator assembly may be in contact with the housing.

### Advantageous Effects

A heat dissipation cap according to the present invention can extend a heat radiation path capable of transferring heat generated by or transferred to a stator coil in a motor to the outside to increase and improve heat dissipation efficiency. In addition, since the heat dissipation cap according to the present invention is very easily coupled to the stator core coupled to the wound coil, a process time and costs can be reduced. In addition, since the heat dissipation cap according to the present invention has a superior mechanical strength, a bonding strength, and a heat resistance property after coupled to the stator core, the heat dissipation cap according to the present invention also has superior durability against vibrations and high temperatures generated when the motor is driven, and thus can achieve a desired effect for a long time. In addition, since the heat dissipation cap for a stator assembly has superior insulation properties, there is an advantage of achieving insulation properties by capping using the heat dissipation cap even when additional insulation coating is not performed on an end of the wound coil, and this advantage can be particularly useful to the motor employing a hairpin wound coil.

### DESCRIPTION OF DRAWINGS

FIG. 1 is a schematic cross-sectional view illustrating a part of a general motor in a rotational axis direction and showing transfer paths of heat generated by a stator.

FIG. 2 is a schematic cross-sectional view illustrating a part of a motor in a rotational axis direction according to one embodiment of the present invention and showing heat a transfer path of heat generated by a stator.

FIG. 3 is a schematic cross-sectional view illustrating a part of a motor in the rotational axis direction according to one embodiment of the present invention.

FIG. 4 are a perspective view illustrating a heat dissipation cap for a stator and a schematic cross-sectional view along line X-X′ according to one embodiment of the present invention.

FIG. 5 is an enlarged cross-sectional view illustrating a part of a stator assembly according to one embodiment of the present invention.

FIG. 6 are a perspective view illustrating a stator assembly and a schematic cross-sectional view along line X-X′ according to one embodiment of the present invention.

FIG. 7 is a schematic cross-sectional view along line Y-Y′ of the stator assembly of FIG. 6.

FIG. 8 are a perspective view illustrating a heat dissipation cap for a stator and a schematic cross-sectional view along line X-X′ according to one embodiment of the present invention.

### BEST MODES OF THE INVENTION

Hereinafter, embodiments of the present invention will be described in detail with reference to the accompanying drawings in order for those skilled in the art to easily perform the present invention. The present invention may be implemented in several different forms and is not limited to the embodiments described herein. Parts irrelevant to descriptions are omitted in the drawings in order to clearly explain the present invention, and the same or similar parts are denoted by the same reference numerals throughout this specification.

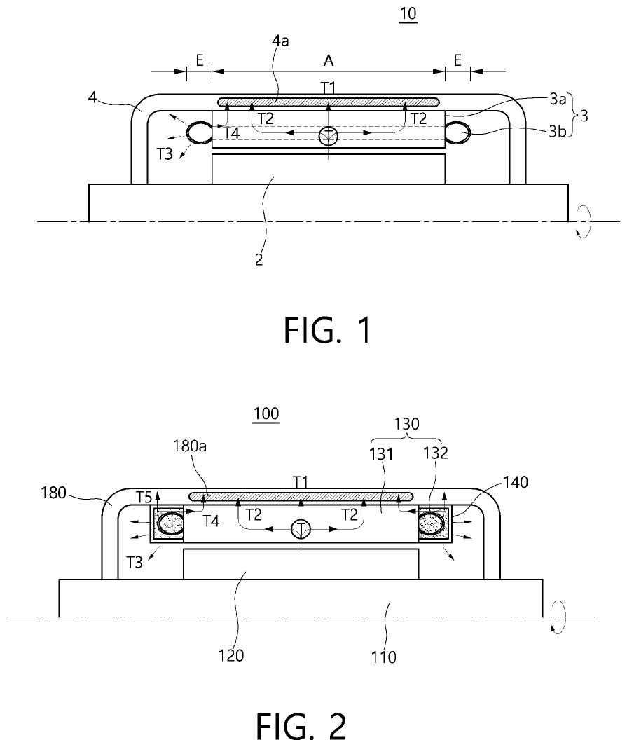

Referring to FIG. 1, a general motor 10 includes a stator assembly 3 disposed inside a housing 4 and a rotor 2 disposed apart from the stator assembly 3 in an inward direction. When a current is applied to the motor 10, heat T in addition to a magnetic force is generated by a wound coil 3b coupled to a stator core 3a, and the heat T is radiated through various paths T1, T2, and T4 and a cooling channel 4a included in the housing 4. Accordingly, since heat radiation from a portion (portion A of FIG. 1) of the wound coil 3b corresponding to an inner side of the stator core 3a is easily performed, a heat radiation issue is small. However, since two ends of the wound coil 3b corresponding to portions (portions E of FIG. 1) of the wound coil 3b protruding outward from two ends of the stator core 3a are directly exposed to air and are not in contact with an object capable of conducting heat, heat generated by or transferred to the two ends of the wound coil 3b is inevitably radiated through the heat transfer path T3 through which heat is radiated into air. In this case, since heat dissipation efficiency from the wound coil 3b to air is very low, heat dissipation from end portions of the wound coil 3b is almost not performed, and thus heat accumulation may increase. When heat is not significantly radiated through the ends of the wound coil 3b, the heat transfer path T4 through which some heat is transferred back to the stator core 3a may be generated. The heat transfer path T₄ may increase heat accumulation, and thus there is a possibility of a decrease in efficiency of the motor.

Accordingly, in the present invention, as a motor 100 is formed by capping two end portions of a wound coil 132 of a stator assembly 130 using heat dissipation caps 140 as illustrated in FIG. 2, heat of the two end portions of the wound coil 132 may be radiated to air through the heat dissipation caps 140 with improved dissipation efficiency. In addition, since a heat flow along a heat transfer path T4 through which the heat of ends of the wound coil 132 is transferred to a stator core 131 decreases, heat accumulation of the stator core 131 and the wound coil 132 coupled to a portion corresponding to the stator core 131 may decrease. In addition, when parts of outer surfaces of the heat dissipation caps 140 are formed in contact with a housing 180, heat transfer paths T5 through which heat of the ends of the wound coil 132 is directly transferred to the housing 180 through the heat dissipation cap 140 are generated, and heat dissipation properties can be significantly improved due to the heat transfer paths T5.

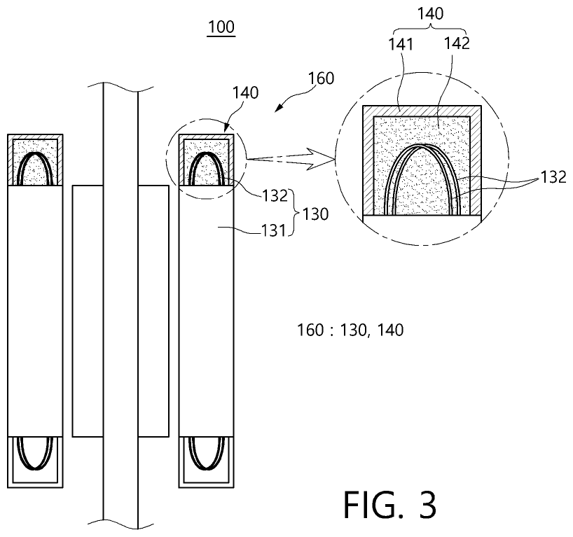

Referring to FIGS. 2 and 3, the motor 100 according to one embodiment of the present invention includes a stator assembly 160 disposed in contact with an inner surface of the housing 180, a rotor 120 which is accommodated in a through hole to be spaced inward from the stator core 131 of the stator assembly 160, and a rotary shaft 110 press-fitted to a central portion of the rotor 120, and the housing 180 may include a cooling channel 180a in a part or entirety of a region corresponding to an outer surface of the stator core 131.

The motor 100 according to the embodiment of the present invention may be used in the known technical field without limitation. As one example, the motor 100 can be applied to a driving motor (electric motor) which obtains a driving force from electric energy in a hybrid vehicle or electric vehicle.

In addition, the housing 180, the rotor 120, and the rotary shaft 110 which are included in the motor 100 may employ configurations which are not changed or are properly changed from those of a housing, a rotor, a rotary shaft included in a known motor. As one example, the rotor 120 may be a rotor applied to a permanent magnet synchronous motor in which a permanent magnet is inserted into a rotor core, or a rotor applied to a wound rotor synchronous motor in which a rotor coil is wound around a rotor core.

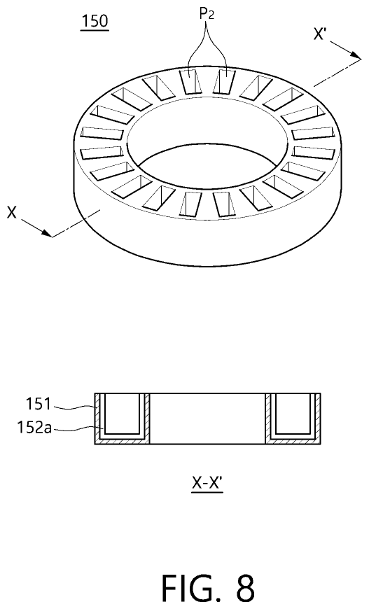

In addition, referring to FIGS. 3 to 8, a stator assembly 160 or 160′ is formed to include a stator 130 or 130′ and heat dissipation caps 140 or 150 and 150′ coupled to two ends of the stator 130 or 130′.

The stator 130 or 130′ includes a cylindrical stator core 131 or 131′ including a through hole through which two ends communicate with the outside and a wound coil 132 or 132′ disposed inside the stator core 131 or 131′, and parts corresponding to the two end portions of the wound coil 132 or 132′ protrude to the outside further than the two ends of the stator core 131 or 131′ in an axial direction of the stator core 131 or 131′, and the remaining parts are positioned inside the stator core 131 or 131′.

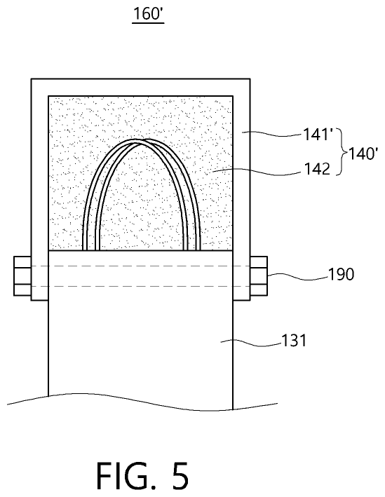

Since a material, a shape, and a size of the stator core 131 or 131′ may employ those of a stator core included in a general motor, the material, the shape, and the size of the stator core 131 or 131′ are not specifically limited in the present invention. Meanwhile, a specific shape of the stator core 131 or 131′ may vary depending on a type of the wound coil 132 or 132′. As one example, as illustrated in FIG. 3, when a conductive wire member is wound around the stator core 131 to form the wound coil 132, a plurality of grooves formed in parallel in a direction toward the rotary shaft 110 may be provided inside the stator core 131 so that the conductive wire member is inserted into and wound around the stator core 131. In addition, as illustrated in FIG. 5, the wound coil 132′ is formed by connecting hairpins like the stator 130′ provided in a hairpin winding motor, the stator core 131′ may include a plurality of slots passing through the two ends of the stator core 131′, and the plurality of slots may be formed so that a group of slots formed apart from each other with predetermined intervals in a circumferential direction form a plurality of layers in a radial direction of the stator core 131′.

In addition, as described above, the wound coil 132 may be formed so that the conductive wire member is wound inside the stator core 131, or the wound coil 132′ may also be formed so that a plurality of hairpins are coupled to the plurality of slots provided in the stator core 131′, and ends of the different hairpins coupled to any one slot are connected by welding or the like. Since a specific shape, a material, a size, and the like of the wound coil 132 or 132′ may employ those of a wound coil for a stator employed in a known motor, the specific shape, the material, the size, and the like of the wound coil 132 or 132′ are not particularly limited in the present invention.

The end portions of the wound coil 132 or 132′ protrude and are exposed from the two ends of the stator 130 or 130′ formed as described above in a rotational axis direction, and the heat dissipation caps 140 or 150 and 150′ are provided on two end portions of the stator core 131 or 131′ such that the protruding end portions of the wound coil 132 or 132′ therein are accommodated in contact with an outer surface of the stator core 131 or 131′.

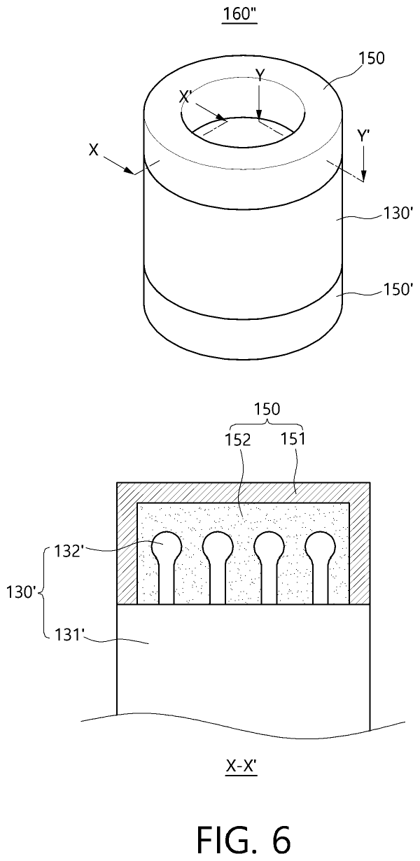

In this case, the outer surface of the stator core 131 or 131′ in contact with the heat dissipation caps 140 or 150 and 150′ may be two end surfaces of the stator core 131 or 131′ as illustrated in FIGS. 3 and 6. Alternatively, as illustrated in FIG. 5, an end surface of the stator core 131 may be in contact with a part of an outer surface extending from the end surface.

In addition, the heat dissipation caps 140 or 150 and 150′ may be fixed to the stator core 131 or 131′ using a heat transfer filling material 142 or 152 provided in the heat dissipation caps 140 or 150 and 150′. Alternatively, as illustrated in FIG. 5, the heat dissipation cap 140′ may be fixed to the stator core 131 by a coupling member 190, which is further provided, to form a stator assembly 160′, and thus, coupling of the heat dissipation cap 140′ and the stator core 131 may be further improved against vibrations, impacts, and the like occurring when the motor operates. In this case, known coupling members may be used in the coupling member 190 without limitation. As one example, the coupling member 190 may include a bolt and a nut.

The heat dissipation caps 140 or 150 and 150′ coupled to the stator core 131 may include a heat radiation exterior member 141 or 151 molded to have an accommodation portion P₁ or P₂ which accommodates one protruding end portion of the wound coil 132 or 132′ and the heat transfer filling material 142 or 152 which fills a space between the heat radiation exterior member 141 or 151 and an accommodated wound coil 132, 132′, or 132″.

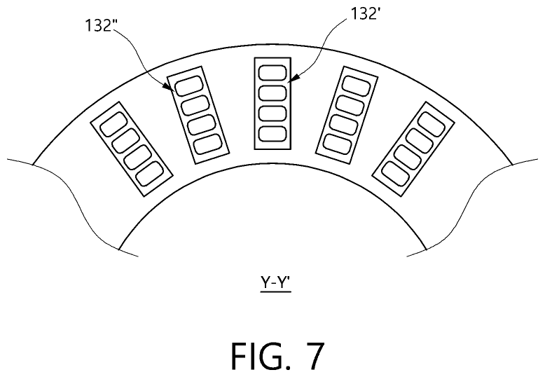

A through hole corresponding to the through hole of the stator core 131 or 131′ may be formed in a central portion of the heat radiation exterior member 141 or 151, and the heat radiation exterior member 141 or 151 may include the accommodation portion P₁ or P₂ having an open front end to correspond to one protruding end portion of the wound coil 132 or 132′ in the circumferential direction. Meanwhile, the heat dissipation cap 150, in which a group of wound coils 132′ and 132″ each formed by four hairpins forming the layer is accommodated in the accommodation portion P₂, is illustrated in FIG. 7. However, unlike FIG. 7, the accommodation portion formed in the heat dissipation cap may be formed to individually accommodate each of four hairpins forming one group.

Any conventional heat radiation plastic serving a heat radiation function may be used for the heat radiation exterior member 141 or 151 without limitation. However, it is preferable that an environment to which the heat radiation exterior member 141 or 151 is applied secures heat radiation properties for high temperatures of the motor, that is, the wound coil 132, 132′, or 132″, thermal durability that contraction, deformation, and crack do not occur at high temperatures, insulation properties, and a mechanical strength that prevents crack due to vibrations even when the motor is driven. Accordingly, a tensile strength of the heat radiation exterior member 141 or 151 may be 2.5 kgf/mm² or more, and more preferably, in the range of 3 to 6 kgf/mm², and a flexural strength may be 7.0 kgf/mm² or more, and more preferably, in the range of 8.0 to 12.0 kgf/mm² based on KS M 3015, and an IZOD impact strength may be 11 kJ/m² or more, and more preferably, in the range of 13 to 18 kJ/m². In addition, an insulation resistance of the heat radiation exterior member 141 or 151 may be 1.0×10¹³Ω or more, and more preferably 1.0×10¹⁴Ω or more, an arc-resistance may be 180 seconds or more, and a thermal deformation temperature may be 190° C. or more.

Any member having physical properties of which levels are higher than or equal to those of the above-described properties may be used as the heat radiation exterior member 141 or 151 without limitation. As one example, the heat radiation exterior member 141 or 151 may be a member formed by curing an exterior material resin composition including a first curable base resin and a first heat dissipation filler. A composition generally known as a bulk molding compound (BMC) may be used as a basic composition of the exterior material resin composition without limitation. As one example, the first curable base resin may be one of an unsaturated polyester, epoxy resin, acrylic resin, nylon resin, phenol resin, urea resin, melamine resin, silicone resin, urethane resin, and the like, or a compound thereof or a resin in which two or more thereof are copolymerized. As one preferable example, the first curable base resin may be an unsaturated polyester. The exterior material resin composition may include the first curable base resin at 10 to 20 wt % based on a total weight of the exterior material resin composition, but is not limited thereto, and the first curable base resin may be properly changed according to a specific type of a base resin and a target physical level.

In addition, the first heat dissipation filler may employ an insulative filler to achieve heat transfer properties and insulation properties at the same time. As one example, the first heat dissipation filler may include one of silicon carbide, magnesium oxide, titanium dioxide, silicon dioxide, aluminum nitride, silicon nitride, boron nitride, aluminum oxide, silica, zinc oxide, barium titanate, strontium titanate, beryllium oxide, talc, and manganese oxide, and as a more specific example, the first heat dissipation filler may include talc. The exterior material resin composition may include the first heat dissipation filler at 50 to 80 wt % based on the total weight, and more preferably, include the first heat dissipation filler at 60 to 68% based thereon. Through this, it can be advantageous for achieving mechanical, electrical, and thermal properties of the above-described heat radiation exterior material.

In addition, the exterior material resin composition may further include a low contraction agent in addition to the first curable base resin and the first heat dissipation filler. The low contraction agent may serve to minimize deformation such as torsion and contraction of the heat radiation exterior material and include the low contraction agent at 9 to 12 wt % based on the total weight. When the low contraction agent at less than 9 wt % is included, there is a risk of deformation of the heat radiation exterior material at high temperatures, the heat radiation exterior material and the stator core may be separated consequently, and thus heat radiation properties may be degraded. In addition, when the low contraction agent at more than 12 wt % is included, since improvement of a contraction prevention effect is small, and contents of other components, for example, the first heat dissipation filler, decrease relatively, it may be difficult to achieve target effects of the other components.

In addition, the exterior material resin composition may further include a reinforcing agent to supplement a mechanical strength and insulation properties of the heat radiation exterior material. As an example, the reinforcing agent may include glass fiber. The exterior material resin composition may include the glass fiber at 8 to 11 wt % based on the total weight. When the glass fiber at less than 8 wt % is included, it may be difficult to supplement the mechanical strength and to improve the insulation properties using the reinforcing agent. In addition, when the glass fiber at more than 11 wt % is included, an increase in mechanical strength improvement effect is small, contents of the other components decrease relatively, and thus it may be difficult to achieve target effects of the other components.

In addition, the exterior material resin composition may further include additives such as a curing agent, a release agent, a thickener, and a pigment, which are typically provided in a bulk molding composition, in addition to the above-described components. Since a specific type and a content for each additive may properly vary depending on a purpose, additives are not particularly limited in the present invention.

The heat transfer filling material 142 or 152 which fills a space between the heat radiation exterior member 141 or 151 and protruding end portions of the wound coil 132, 132′, or 132″ may be disposed in the above-described heat radiation exterior member 141 or 151. The heat transfer filling material 142 or 152 provides a heat transfer path between the heat radiation exterior member 141 or 151 and the wound coil 132, 132′, or 132″ and serves a function of fixing the heat dissipation caps 140 or 150 and 150′ to one ends of the stator 130 or 130′. The heat transfer filling material 142 or 152 may be formed using the heat transfer filling composition 142a or 152a. The heat transfer filling composition 142a or 152a may include a second curable base resin and a second heat dissipation filler. In addition, the heat transfer filling composition provided in the heat dissipation caps 140 or 150 and 150′ which are in an individual part state before coupled to the stator 130 or 130′ may be in an A-stage state in which curing is not performed or a B-Stage state in which curing is partially performed. The heat dissipation caps 140 or 150 and 150′ including the heat transfer filling composition 142a or 152a in the uncured or partially cured state are coupled to one ends of the stator 130 or 130′, and the heat transfer filling composition 142a or 152a may be formed into the heat transfer filling material 142 or 152 while cured through a heat treatment and/or by emitting light according to a curing type of the second curable resin.

A curable resin may be used as the second curable base resin without limitation, and as one example, the second curable base resin may be one or more of epoxy resin, unsaturated polyester resin, polyurethane resin, and silicone resin and, more specifically, epoxy resin or unsaturated polyester resin. In addition, the heat transfer filling composition 142a or 152a may include the second curable base resin at 10 to 70 wt % based on a total weight of the heat transfer filling composition 142a or 152a, but is not limited thereto, and may properly vary depending on a type of a specific base resin and a target physical level.

In addition, a known heat dissipation filler may be used as the second heat dissipation filler without limitation, and it is preferable to have all insulation properties and heat transfer properties. As one example, the second heat dissipation filler may include one or more of silicon carbide, magnesium oxide, titanium dioxide, silicon dioxide, aluminum nitride, silicon nitride, boron nitride, aluminum oxide, aluminum hydroxide, silica, zinc oxide, barium titanate, strontium titanate, beryllium oxide, and manganese oxide, and as one more specific example, the second heat dissipation filler may be aluminum hydroxide. The heat transfer filling composition 142a or 152a may include the second heat dissipation filler at 20 to 80 wt % based on the total weight, and more preferably, include the second heat dissipation filler at 45 to 68 wt % based thereon, but is not limited thereto, and the second heat dissipation filler may properly vary depending on a specific type of the heat dissipation filler, a type of a curable resin forming a matrix of an exterior material, and a target physical level.

In addition, the heat transfer filling composition 142a or 152a may further include additives such as a hardener, a thickener, a filler, and a reinforcing agent in addition to the second curable base resin and the second heat dissipation filler. Since a specific type and a content for each additive may properly vary depending on a purpose, additives are not specifically limited in the present invention.

A volume resistance of the heat transfer filling material 142 or 152, in which the heat transfer filling composition 142a or 152a is cured, may be 2×10¹¹ Ω·cm or more based on ASTM D 257, a dielectric breakdown strength is 9 kV/mm or more based on ASTM 149, a thermal conductivity may be 0.5 W/mk or more based on ASTM E 1530, and thus superior insulation properties and a thermal conductivity property can be achieved at the same time.

### MODES OF THE INVENTION

Although the present invention will be more specifically described with reference to an example below, the following example does not limit the scope of the present invention and should be interpreted as helping understanding of the present invention.

### EXAMPLE 1

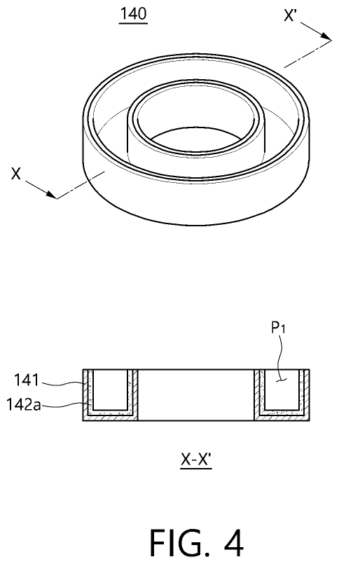

In order to prepare the heat radiation exterior material, a composition for preparing the heat radiation exterior material, which included an unsaturated polyester resin at 14 wt % as the first curable base resin, talc at 65 wt % as the first heat dissipation filler, the low contraction agent at 10 wt %, glass fiber at 10 wt % as the reinforcing agent, the curing agent at 0.6 wt %, and the release agent at 0.4 wt %, was prepared, and the composition for preparing the heat radiation exterior material was input to a mold designed to match an outer diameter and an inner diameter of the stator core and a size of the wound coil and molded at a temperature of 120° C. to prepare the heat radiation exterior member having a shape illustrated in FIG. 4.

The heat transfer filling composition having a predetermined thickness was treated on a side surface and a lower surface of the accommodation portion P1 in the prepared heat radiation exterior material and treated at 85° C. for four hours to prepare in a B-Stage state. In this case, the heat transfer filling composition prepared so that a first agent including an epoxy resin at 45 wt % as the second curable base resin and aluminum hydroxide at 55 wt % as the second heat dissipation filler and a second agent which was a curing agent were contained in a weight ratio of 1:0.4 was used. Then, the heat dissipation caps including the prepared heat dissipation exterior material and the heat transfer filling material was assembled with the two ends of the stator in which the wound coil formed of a copper material was installed on the stator core and thermally treated at 90° C. for three hours to cure the heat transfer filling material and manufacture the stator in which the heat dissipation caps were fixed to the two ends.

In this case, physical values of the heat radiation exterior member and the heat transfer filling material prepared in Example 1 were measured as in Table 1 below.

TABLE 1

| | Item | Measured Value | Note |
|---|---|---|---|
| Heat radiation | Tensile Strength (kgf/mm²) | 3.6 | KS M 3015 |
| exterior member | Flexural Strength (kgf/mm²) | 9.1 | |
| | Compressive Strength (kgf/mm²) | 9.3 | |
| | IZOD Impact Strength (kj/m²) | 15.9 | ASTM D256 |
| | Insulation Resistance (Ω) | 1 × 10¹⁴ | ASTM D257 |
| | Dielectric Breakdown Strength (KV/mm) | 12 | ASTM D149 |
| | Arc-resistance (sec) | 180 | ASTM D495 |
| | Thermal Deformation Temperature (° C.) | 190 | ASTM D648 |
| | Thermal Conductivity (W/mK) | 1.97 | ASTM E1461 |
| Heat transfer | Volume Resistance (Ω · cm) | 1 × 10¹⁴ | ASTM D 257 |
| filling material | Dielectric Breakdown Strength (KV/mm) | 25 | ASTM D 149 |
| | Hardness (Shore D) | 90 | ASTM D 784 |
| | Thermal Conductivity (W/mK) | 0.6 | ASTM E 1530 |

### COMPARATIVE EXAMPLE 1

A stator in which any treatment was not performed on a wound coil protruding to the outside was made.

### EXPERIMENTAL EXAMPLE 1

In a constant temperature and humidity room, a current of 10 A was applied to a wound coil of a stator for one hour according to each of Example and Comparative Example, and temperatures of a left end, a right end, and an outer surface of a central portion of the stator were checked.

Specifically, a heat sink was positioned on an outer surface of a stator core of the stator, and the heat sink was pressed using the same jig so that there was no gap at an interface between the outer surface of the stator core and the heat sink. In this case, the outer surface of the stator core was coated with a thermal interface material (TIM) which had a thermal conductivity of 1.8 W/mK and a predetermined thickness so that the TIM was positioned between the outer surface of the core and a contact surface of the heat sink. In addition, in the case of Example 1, the heat sink having a length which was greater than a length of the stator core by a protruding length of the wound coil which protrudes to the outside was used to maintain a state in which the outer surface of the heat radiation exterior material was in contact with the heat sink as illustrated in FIG. 2, and in the case of Comparative Example 1, there was no contact point between the heat sink and the wound coil as illustrated in FIG. 1.

A current of 10 A was applied to each of formed two test wound coils for one hour, and a temperature was measured after one hour and written in Table 2 below.

TABLE 2

| | | Example 1 | Comparative Example 1 |
|---|---|---|---|
| Heat Dissipation Cap | | Heat Radiation Exterior Material + | Not available |
| Presence or Absence | | Heat dissipation filling composition | |
| Temperature (° C.) | Left End | 124.2 (−22.4) | 146.6 |
| after One Hour | Central Portion | 119.1 (−21.6) | 140.7 |
| | Right End | 123.8 (−22.6) | 146.4 |

As shown in Table 1, when the heat dissipation cap according to Example 1 was assembled with the stator, a temperature, which was about 15% lower than a temperature of Comparative Example 1 in which there was no heat dissipation cap, was achieved, and it showed that heat generated by the stator could be effectively radiated through the heat dissipation cap.

While embodiments of the present invention have been described above, the spirit of the present invention is not limited to the embodiments proposed in this specification, and other embodiments may be easily suggested by adding, changing and removing components by those skilled in the art and will fall within the spiritual range of the present invention.

1. A stator assembly comprising:
a stator including a stator core having a cylindrical shape and a through hole through which two ends communicate with an outside and a wound coil having parts protruding to the outside further than the two ends of the stator core in an axial direction of the stator core and the remaining part positioned in the stator core; and
heat dissipation caps which are provided on two end portions of the stator core such that the protruding parts of the wound coil are accommodated in contact with an outer surface of the stator core.

2. The stator assembly of claim 1, wherein the wound coil is formed by:
winding a conductive wire member; or
coupling and connecting a plurality of hairpins to a plurality of slots provided in a circumferential direction of the stator core to pass through the two ends of the stator core.

3. The stator assembly of claim 1, wherein each of the heat dissipation caps includes:
a heat radiation exterior member molded to have an accommodation portion which accommodates one protruding end portion of the wound coil; and
a heat transfer filling material which fills a space between the heat radiation exterior member and the accommodated wound coil.

4. The stator assembly of claim 3, wherein:
a through hole corresponding to the through hole of the stator core is formed in a central portion of the heat radiation exterior member; and
the heat radiation exterior member includes the accommodation portion having an open front end to correspond to the one protruding end portion of the wound coil in a circumferential direction.

5. The stator assembly of claim 3, wherein the heat radiation exterior member is formed by curing an exterior material resin composition including a first curable base resin and a first heat dissipation filler.

6. The stator assembly of claim 3, wherein the heat transfer filling material is formed by curing a heat dissipation filling composition including a second curable base resin and a second heat dissipation filler after the wound coil is accommodated in the heat radiation exterior member.

7. The stator assembly of claim 3, wherein the heat radiation exterior member has a tensile strength of 2.5 kgf/mm² or more and a flexural strength of 7.0 kgf/mm² or more based on KS M 3015 and has an IZOD impact strength of 11 kJ/m² or more.

8. The stator assembly of claim 3, wherein the heat radiation exterior member has:
an insulation resistance of 1.0×10¹³Ω or more;
an arc-resistance of 180 seconds or more; and
a thermal deformation temperature of 190° C. or more.

9. The stator assembly of claim 3, wherein the heat transfer filling material has:
a volume resistance of 2×10¹¹ Ω·cm or more based on ASTM D 257;
a dielectric breakdown strength of 9 kV/mm or more based on ASTM 149; and
a thermal conductivity of 0.5 W/mk or more based on ASTM E 1530.

10. The stator assembly of claim 1, wherein the heat dissipation cap is fixed to the stator core using a coupling member.

11. A heat dissipation cap for a stator, which is coupled to one end portion of a stator core to radiate heat of a wound coil wound around the stator core of a motor, the heat dissipation cap comprising:
a heat radiation exterior member molded to form an accommodation portion which accommodates one end portion of the wound coil; and
a heat dissipation filling composition provided in the accommodation portion to fill a space between the heat radiation exterior member and the wound coil after the one end portion of the wound coil is accommodated in the accommodation portion.

12. The heat dissipation cap of claim 11, wherein:
the heat dissipation filling composition includes a second curable base resin; and
the second curable base resin is in an uncured or partially cured state.

13. A motor comprising:
the stator assembly of claim 1;
a rotor accommodated in a through hole inside a stator core of the stator assembly; and
a housing which accommodates a stator assembly to be in contact with an outer surface of the stator core of the stator assembly and includes a cooling channel in a region corresponding to the outer surface of the stator core.

14. The motor of claim 13, wherein at least a part of an outer surface of the heat dissipation cap in the stator assembly is in contact with the housing.
